(19) United States
(12) Patent Application Publication
(10) Pub. No.: US 2008/0005347 A1
(43) Pub. Date: Jan. 3, 2008

(54) MESSENGER SYSTEM FOR PUBLISHING PODCASTS

(75) Inventor: Edward Stanley Ott, Palo Alto, CA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/427,622

(22) Filed: Jun. 29, 2006

(51) Int. Cl. G06F 15/16

(52) U.S. Cl. 709/231

(57) ABSTRACT

The present invention relates to a messenger system adapted to support the creation and publication of podcast episodes (either audio or video) from communications made via the messenger system. The messenger system may be entirely server-based, may require the use of limited client side software or may be entirely client based. The messenger system allows a user to select that a call be recorded for later use causing the messenger software to store the various audio and any video streams provided from each party to the call. A user interface is then provided that allows the user, after the call, to edit, combine, modify, or add to the different audio and video streams as desired to create a single media file containing audio or audiovisual data. This media file may then be published as an episode to a podcast.

### BACKGROUND

Multimedia data files, or media files, are data structures that may include audio, video or other content stored as data in accordance with a container format. A container format is a file format that can contain various types of data, possible compressed a standardized and known manner. The container format allows a rendering device to identify, and if necessary, interleave, the different data types for proper rendering. Some container formats can contain only audio data, while other container formation can support audio, video, subtitles, chapters and metadata along with synchronization information needed to play back the various data streams together. For example, an audio file format is a container format for storing audio data. There are many audio-only container formats including known in the art including WAV, AIFF, FLAC, WMA, and MP3. In addition, there are now a number of container formats for use with combined audio, video and other content including AVI, MOV, MPEG-2 TS, MP4, ASF, and RealMedia to name but a few.

Media files accessible over a network are increasingly being used to deliver content to mass audiences. For example, one emerging way of periodically delivering content to consumers is through podcasting.

Podcasting is a method of publishing digital media, typically audio or video programs, via the Internet, allowing users to subscribe to a series of new files (e.g., .MP3 audio files) as they become available over time. The word “podcasting” became popular in late 2004, largely due to automatic downloading of audio onto portable players or personal computers. Podcasting is distinct from other types of online media delivery because of its subscription model, which uses a “feed” (such as RSS, discussed below, and Atom) to monitor for and/or deliver a file. A feed in this context refers to an electronic means, such as a file containing a list of media files (referred to as “episodes” of the feed), that can be easily interpreted to identify new episodes in the list as the episodes are added over time. Specialized software on the user's computer may be used to occasionally check the feed for new episodes. Thus, one is said to subscribe to a feed because as new episodes are listed in the feed, the subscriber (via the software) is notified of the new file and, in some cases, the new file is automatically retrieved by the software.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and may download new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, although the “podcast” name remains most associated with audio. Other names are sometimes used for casting other forms of media, such as blogcasting for text and vcasting, vlogging or vodcasting for video. For the purposes of this application, podcast is used in its most general sense to refer to a list of new files in any format (e.g., .MP3, .MPEG, .WAV, .JPG) and containing any content (e.g., text-based, audible, visual or some combination) that can be subscribed to. Also, for the purposes of this discussion an individual podcast feed may be alternately referred to as a series. Each distinct new file in a series or feed may be referred to as an individual episode of the series.

Podcasting is supported by underlying feed formats, of which RSS is but one example. RSS is a family of XML file formats for web syndication used by (among other things) news websites and weblogs. The abbreviation is alternately used to refer to the following recognized standards: Rich Site Summary (RSS 0.91); RDF Site Summary (RSS 0.9 and 1.0); and Really Simple Syndication (RSS 2.0).

Feed formats, such as the RSS formats, often allow the feed creator (referred to as the publisher) to include web content or summaries of web content together with links to the full versions of the content, and other meta-data. This information may be associated with different episodes of the feed, thus allowing an easy way to provide at least some summary information to the subscriber so that a subscriber does not have to render each episode to determine if it contains information of interest. This information may be delivered within an XML feed file, a webfeed, an RSS stream, or RSS channel.

The technology behind podcasting allows a client to subscribe to websites that have provided RSS feeds or feeds in other formats; these are typically sites that change or add content regularly. To use this technology the client needs some type of RSS aggregation service or aggregator. The aggregator allows a client to subscribe to the podcasts that the client wants to monitor or to get updates (i.e. future media files in the feed) on. Unlike typical subscriptions to pulp-based newspapers and magazines, RSS subscriptions are free, but they typically only provide a line or two of each article or post along with a link to the media file that contains the episode (e.g., the full text article, audio file or video file). In addition to facilitating syndication, a feed allows a website's frequent readers to track updates on the site using an aggregator.

Feeds, including RSS feeds, are widely used by the weblog community to share the latest episodes' headlines or their full text, and even attached multimedia files. In mid 2000, use of RSS for podcasting text spread to many major news organizations, including Reuters, CNN and the BBC, until under various usage agreements, providers allow other websites to incorporate their “syndicated” headline or headline-and-short-summary feeds. Feeds are now used for many purposes, including marketing, bug-reports, or any other activity involving periodic updates or publications.

Podcasting has become a very popular and accepted media delivery paradigm. This success has caused the number and variety of podcasts available to clients to grow exponentially. Potential podcast consumers are now confronted with the problems of how to find podcasts; how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

At the same time, a new type of communication system, referred to as messenger systems, has become popular. Messenger systems are software and/or services that allow a user of a personal computer or other computing device with a connection to the Internet or similar network to make 2-way audio communications, or “calls”, to or to receive calls from other people's computers or even traditional telephones. An example of such a service is Yahoo!® Messenger™. Using Messenger, a user may initiate calls from a personal computer, through Yahoo!'s servers to any telephone or any other computer on the Internet. The user need only have a browser and Yahoo!'s client software installed on the computer and the messenger system then manages turning the audio information from the connected devices into Voice Over Internet Protocol (VOIP) communications.

In addition to audio only calls, commonly referred to as telephone calls regardless of the network or networks used, Messenger also allows users to make “video calls”, sometimes also referred to as web conferencing, in which one or both of the parties to the call can see the other party in real time during the call in addition to hearing the audio provided by the parties. To support a video call, a computer or other device must have video camera capabilities. However, it is now common for personal computers to be provided with web cameras (web cams) so this type of service is becoming more popular. In a video call, a user may select to have video available to the other party assuming that the other party has video display capabilities. Alternately, a user may select to prevent the display of the video to the other party, allowing only an audio call to be made.

### SUMMARY

The present disclosure relates to a messenger system adapted to support the creation and publication of podcast episodes (either audio or video) from communications made via the messenger system. The messenger system may be entirely server-based, may require the use of limited client side software or may be entirely client based. The messenger system allows a user to select that a call be stored for later use causing the messenger software to store the various audio and any video streams provided from each party to the call. A graphical user interface is then provided that allows the user, after the call, to edit, combine, modify, or add to the different audio and video streams as desired to create a single media file containing audio or audiovisual data. This media file may then, through another user interface, be published as an episode to a podcast.

One aspect of the present disclosure describes a computer-implemented method that includes receiving, from a first device, a request to open a communication connection with a second device and opening the communication connection. In addition, the method includes receiving a request to record communications between the first device and the second device and, in response, recording a first stream of data generated by the first device for transmission to the second device and recording a second stream of data generated by the second device for transmission to the first device. The first stream of data and the second stream of data are stored. In response to one or more first user inputs, a user-selected portion of the first stream of data or the second stream of data are then stored separately in a media file that is accessible at a location on a network. The method also includes, in response to one or more second user inputs, identifying the location of the media file in a podcast accessible on the network, thereby publishing the media file on the network as an episode of the podcast.

Another aspect of the present disclosure may be considered a system for publishing an episode of a podcast. The system includes: a messenger module adapted to communicatively connect a client computing device with a second device and further adapted to record a first communication data stream from the client computing device and a second communication data stream from the second device; an editing module adapted to create a media file containing data selected from the first communication data stream and the second communication data stream; and a podcast publishing module adapted to generate an episode entry corresponding to the media file in the podcast, the episode entry identifying the media file as the episode.

Yet another aspect of the present disclosure may be considered a method that includes initiating a communication between at least two communication devices, including a first communication device and a second communication device, using a messenger server. The method further includes recording, by the messenger server in response to a first selection made by at least one of the two communication devices, media data passed between the two communication devices during the communication. A media file derived from at least some of the media data passed between the two communication devices during the communication is then generated, the media file when rendered reproducing at least a portion of the communication between the two communication devices.

Yet another aspect of the present disclosure may be considered a method of creating and publishing an episode using a messenger service including initiating, from a first computing device, a communication through a messenger service with a second device; directing the messenger service to record the communication; after the communication, directing the messenger service to create a media file renderable to reproduce at least a portion of the communication; and directing the messenger service to publish the media file as an episode of a podcast.

These and various other features as well as advantages which characterize the described systems and methods will be apparent from a reading of the following detailed description and a review of the associated drawings. Additional features are set forth in the description which follows, and in part will be apparent from the description, or may be learned by practice of embodiments of the described systems and methods. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the described systems and methods and are not meant to limit the scope of the possible embodiments in any manner, which scope shall be based on the claims appended hereto.

FIG. 1 is a high-level flowchart illustrating an embodiment of a method 10 for publishing a podcast episode with a messenger system.

FIG. 2 is a computing architecture illustrating an embodiment of a messenger system adapted to create media files from communications and publishing those files as episodes of podcasts.

FIG. 3 illustrates a flowchart of an embodiment of a method 300 for creating and publishing an episode of a podcast.

### DETAILED DESCRIPTION

As used herein, the terms “episode,” “content”, “media”, or “media files” are used broadly to encompass any product type or category of renderable, experienceable, retrievable, computer-readable filed and/or stored media, either singly or collectively, and individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term content includes all types of media content such as audio and video and products embodying the same. As mentioned above, while there are many digital forms and standards for audio, video, digital or analog media data and content, embodiments of the systems and methods described herein may be equally adapted to any format or standard now known or to become known.

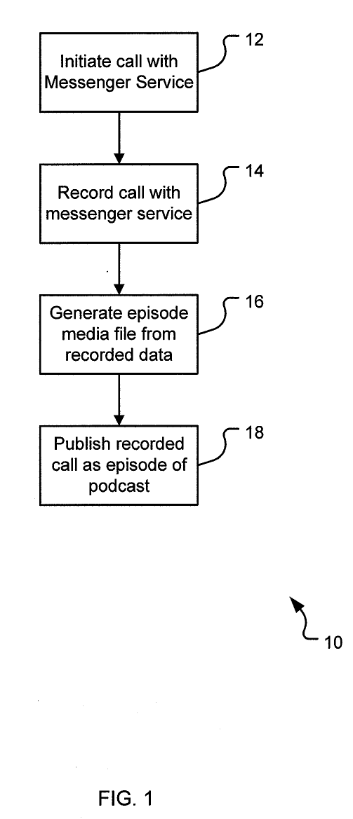

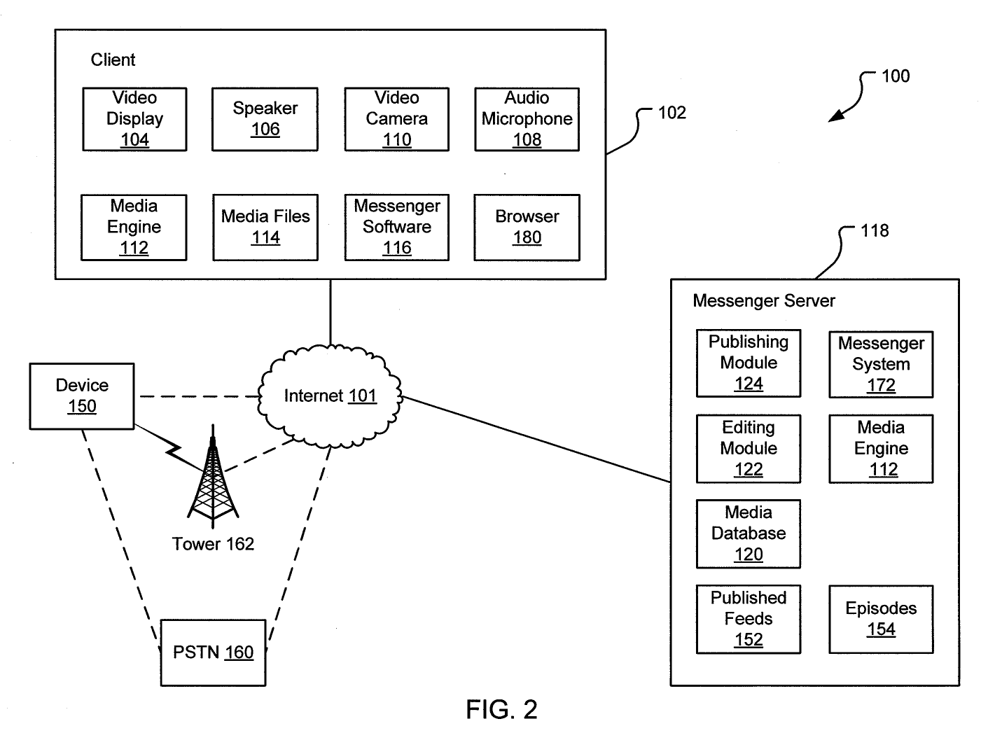

FIG. 1 is a high-level flowchart illustrating an embodiment of a method 10 for publishing a podcast episode with a messenger system. In FIG. 1, a caller uses a messenger system to call another communication device, which may be a telephone, a computer, a cellular telephone or some other communication device now known or later developed. In the embodiment shown, the caller initiates the call in an initiation operation 12 in which the caller may provide important information to the messenger system such as a telephone number, an IP address, a network address or some other communication device identifier that the messenger system can use to identify and connect to the device being called. In order to initiate the caller, the caller may utilize a client computing device, such as a personal computer or a wireless computing device, equipped with a browser or messenger software that allows the client computing device to interact with the messenger system. The messenger system may be located on the caller's computing device or, as shown in FIG. 2 below, on a server remote from the client computing device and connected to it via a communication network such as the Internet.

During the call, the messenger system records the communications between the caller's device and the called device in a record operation 14. In an embodiment the record operation 14 may include recording separate streams of data, e.g., the stream of audio generated by the caller's device and the stream of audio generated by the called device, as separate data files, with information about how the two files should be synchronized to reproduce the contents of the call. In an alternative embodiment the record operation 14 may include creating a single media file that combines the two audio streams into a single recording.

If visual data is included in the call, i.e., one or more of the devices connected in the call is transmitting visual data along with audio data, the visual data may also be stored separately. Alternatively, the combined audio-visual data generated by each device may be recorded separately (such as in an MPEG or other video data format) in separate media files. In this way, the visual information generated by each of the different devices is separately retained and may be viewed by a reviewer. Again, synchronization information may also be stored with the visual data so that all of the streamed data may be synchronized when played back.

After the call is completed, the recorded data is used to generate a media file suitable for use as an episode of a podcast in a generate episode operation 16. The generate episode operation 16 may include creating a single media file from the various recorded streams. The single media file may be a simple combination of all the various audio streams necessary to recreate the entire audio data of the call. The generate episode operation 16, if there is visual data from one or more of the device in the call, may use all the video from a selected device. Alternatively, an editor may be able to select different visual data streams during different portions of the call to be shown. This is particularly useful if the call is an interview, allowing the editor to show the interviewer while the interviewer is asking a question and then show the interviewee during the answer. Episode information, such as title, description, date, etc. may be generated at this time and recorded as part of the media file or in a separate data record associated with the media file for use in the publication operation 18.

The episode is then published in a publication operation 18. In the publication operation 18, an episode entry is generated and added to a podcast feed file. The episode entry may contain episode information provided by one or more of the caller, an editor, and the messenger system. This may include retrieving a copy of the current podcast feed file, adding the episode entry, and overwriting the original feed file with the revised version containing the new episode. The episode entry added to the feed file includes a location of the episode's media file. This location may be the location that the media file was stored at in the generate episode operation 16. Alternatively, the episode media file may be saved into a new location on the network as part of the publication operation 18 and this location may then be referenced or linked to in the episode entry. In an embodiment, the publication operation 18 may be performed via the messenger system under direction of the caller or the editor.

FIG. 2 is a computing architecture illustrating an embodiment of a messenger system adapted to create media files from communications and publishing those files as episodes of podcasts. Although numerous exemplary embodiments will be discussed in terms of an interview between two parties, this system can also be utilized with any number of parties and is equally applicable to audio only, video only and audiovisual content.

In addition, although numerous exemplary embodiments will also be discussed in terms of a personal computer used as a client system, embodiments of the systems described herein can also be utilized with any form of computing device including a mobile computing device that can communicate via the messenger system over any network now known or to become known with any other communication device including telephones, cellular telephones, and other computing devices.

The system shown in FIG. 2 includes a client-server system in which a client computing system 102 (the “client” 102) communicates through a messenger server 118 with a second device 150, which may or may not be a computing device. The various devices are connected via a network 101 such as the Internet 101 as shown. Although FIG. 2 illustrates only one client 102 and one device 150 in order to describe a call between two parties, the reader will understand that any number of clients 102 and devices 150 may be used in conference call embodiments between three or more parties.

The client 102 is a computing device, such as a personal computer (PC), web-enabled personal data assistant (PDA) or a smart phone. The client 102 is connected to the Internet 101 via a wired data connection or wireless connection such as a wi-fi network, a WiMAX (802.16) network, a satellite network or cellular telephone network.

In the embodiment described in FIG. 2, the client 102 includes a video monitor or display 104 that can render video to a user, a speaker 106 for playing audio to the user, a microphone 108 for receiving the audio from the user and a video camera 110 for taking video of the user.

In an embodiment, a computing device such as the client 102 includes a processor and memory for storing data and software. In an embodiment, computing devices are further provided with operating systems and can execute software applications in order to manipulate data. In the computing device, local files, such as media files 114, may be stored on a mass storage device (not shown) that is connected to or part of any of the computing devices described herein including the client 102 or a server 118. A mass storage device and its associated computer-readable media, provide non-volatile storage for the client 102. Although the description of computer-readable media contained herein refers to a mass storage device, such as a hard disk or CD-ROM drive, it should be appreciated by those skilled in the art that computer-readable media can be any available media that can be accessed by the client 102.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In the embodiment shown, the client 102 includes an Internet browser 180, such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users.

The client 102 may also include a media engine 112. The media engine 112 may be a software application, a hardware component or some combination of the two that is adapted to receive and handle media data. The media engine 112 can cause media data to be rendered to the user via the video display 104 and the speaker 106. In addition, the media engine 112 may also be utilized in receiving media data from the microphone 108 and the camera 110 for storage or transmission to another device.

The client may also include messenger software 116 as shown. The messenger software 116 is software that is executed on the client 102 to assist the client 102 in interacting with the messenger server 118. In an alternative embodiment, the client 102 may not need specialized messenger software 116 in order to utilize the messenger server 118—the messenger server 118 being adapted to interact with the client 102 and its user through non-specific applications such as the browser 180 and the media engine 112.

FIG. 2 also shows another device 150 that is participating in the call. In the architecture 100 shown, the device 150 may be a computing device as described above with reference to the client 102. However, the device 150 may also be a simple telephone handset, a cellular phone, or some other device capable of making a connection to the Internet 101, either directly or through some other network such as the “plain old telephone system” (POTS), sometimes also referred to as the publicly switched telephone network (PSTN) 160. FIG. 2 shows three different possible connection routes to the device from the server 118, although many others are possible. They are a direct connection from the Internet 104 as would be used for a computing device with direct access to the Internet 101; a wireless connection with a transmission tower 162 such as via a local area network, a wide area network or a cellular telephone wireless network; and a telephone connection via the PSTN 160.

The architecture 100 also includes messenger server 118, which may be a single server or a group of servers acting together. In addition to serving media over the Internet 101 to the user, messenger server 118 also may include a media database 120, which stores or communicates with storage of various metadata attributes of each particular piece of media. Database 120 may be distributed over multiple servers or locations. Other servers (not shown) make other content and services available through or for the messenger server 118 and may provide administrative services such as managing user logon, service access permission, digital rights management, and other services made available through a service provider.

In the embodiment shown, the messenger server 118 publishes podcasts. That is, the server 118 includes or has access to one or more feeds 152, such as RSS feeds, that are accessible through the network, in this case the Internet 101, by clients with the appropriate software. The feeds 152, as will be described in greater detail below, may include information about the feed (e.g., series information) as well as information about the various media files 154 (i.e., episodes) of the feed 152. Each feed 152 also identifies the media files 154 that are the episodes of the feed so that they can be retrieved by an aggregator. In alternative embodiments, either the feeds 152, the media files 154 or both may reside on different servers (not shown).

The messenger server 118 includes a messenger system 172. In an embodiment, the messenger system 172 provides a graphical user interface (GUI) to users allowing the user to access the features of the messenger system 172 via a browser. The GUI may be an .HTML or WAP page that can be served to a computing device for display to the user, such as via a browser. WAP refers to the Wireless Application Protocol, which is an open international standard for applications that use wireless communication (for example, Internet access from a mobile phone). WAP was designed to provide services equivalent to a web browser with some mobile-specific additions, being specifically designed to address the limitations of very small portable devices. Alternatively, the GUI may be presented to the user through some other software on the computing device, such as the messenger software 116.

In the embodiment shown, the messenger system 172 is adapted to receive connection requests from a first device (the “call source”), such as the client 102, and make a connection to the call target. In an embodiment, the call source may be a client 102 that can interface with the GUI via a browser in order to provide a telephone number, instant messaging (IM) address, e-mail address, internet protocol (IP) address or some other identifier that the messenger system 172 can resolve to another device that is the target of the call. In response to this request, the messenger system 172 completes the connection to the target device.

In an alternative embodiment, the messenger software 116 may be adapted to make the connection directly, without connecting through the central node of the messenger system 172. The messenger system 172 may still be used to facilitate the connection, but may not be a necessary node through which all communication passes.

The messenger system 172 may support audio only or video (i.e., calls with an audio and a visual component) calls between devices. The messenger system 172 controls the routing and delivery of the different streams of audio and video data (depending on the call type) from each device.

In addition to making and maintaining the connection, embodiments of the messenger system 172 and/or the messenger software 116 can also record the content of the calls made. In a server embodiment, the messenger server 172 utilizes a media engine 112, which may or may not be a separate module, to record each of the streams of data as described below.

In the embodiment, a user may select to have the call recorded. In one embodiment, in response to such a selection the messenger system 172 or the messenger software 116, depending on the embodiment, then records the various streams of data and stores them, such as in the media database 120, for later use by the recording party. In an alternative embodiment, the various streams of data may be stored on the requesting party's device or at a location designated by that party.

The data may be stored as a single combined media file with information usable by the messenger system 172 to recreate the individual streams or a group of separate media files that can be correlated and played together by the messenger system 172 to recreate the call. For example, the audio data provided by the calling party may be stored as a separate media file while the audio data provided by the called party is stored in a different media file. When the recorded call is played back at a later time, the messenger system 172 can render the data from the two media files simultaneously to generate the combined audio of the call. The recorded data may be stored so that each stream can be rendered separately, so that noise or undesired data from a different stream can be easily removed.

The video streams of data, if any, may likewise be stored in separate media files. When rendering the recorded call, the messenger system 172 may then generate two different displays side by side, one showing the caller's video stream and the other showing the called party's video stream.

Thus, the messenger system 172 operates to recombine all the data in order to provide an accurate playback of each of the different streams of data in the proper synchronization. In an embodiment, the combination may take place at the client 102 or the server 118.

The messenger system 172 is further provided with an editing module 122 adapted to allow the user to edit the recorded call after the call in order to easily create a media file that can be used as an episode of a podcast. In an embodiment, the editor module 122 through a podcast builder/editor module GUI allows a user to select a stream or a group of streams and portions from selected streams. The selected portions may then be combined (if multiple streams are selected) and stored into a single, combined media file in a standard format, such as .MP3, .WAV, ASP or .MOV for example. The user may then direct the server 118 to use the combined media file as an episode of a selected podcast through the podcast builder GUI.

The messenger system 172 may be adapted to allow the selection of pre-existing media files in addition to the various streams created from the call. The pre-existing media files may be provided by the user at the time of the editing. Thus, the user can easily build a podcast episode using the data recorded from the call and additional media content obtained from other sources. The combined data may then be saved into a combined media file.

The messenger system 172 may also include or interact with a publishing module 124. The publishing module 124 may be accessed by the podcast builder GUI or by a publishing GUI. Through such GUI, the publishing module 124 further supports the use of the combined media file by allowing the user to immediately designate combined media file as a podcast episode. The user selects the podcast to be revised using the GUI and then directs the messenger system 172 and/or the publishing module 124 to use the combined media file as the new episode. The user may also be prompted to provide additional information such as a title for the episode, a short description of the episode, etc., that will be added to the podcast feed 152.

The publishing module 124 then takes the information and generates a new episode entry for the media file, as described in greater detail below. The publishing module 124 then creates a new version of the identified podcast and overwrites the original version of the podcast.

In the architecture 100 shown, the messenger server may include published podcasts 152 as shown. In an alternative embodiment, podcasts may be stored at any location on the network and published podcasts at any publicly accessible locations on the network. Similarly, the messenger server 118 is also illustrated as the location of media files 154 that comprises the episodes of published podcasts 152. Each of the episodes 154 may be stored at a publicly accessible location on the messenger server 118. In an alternative embodiment, the episodes may be stored in remote servers accessible via the network 101.

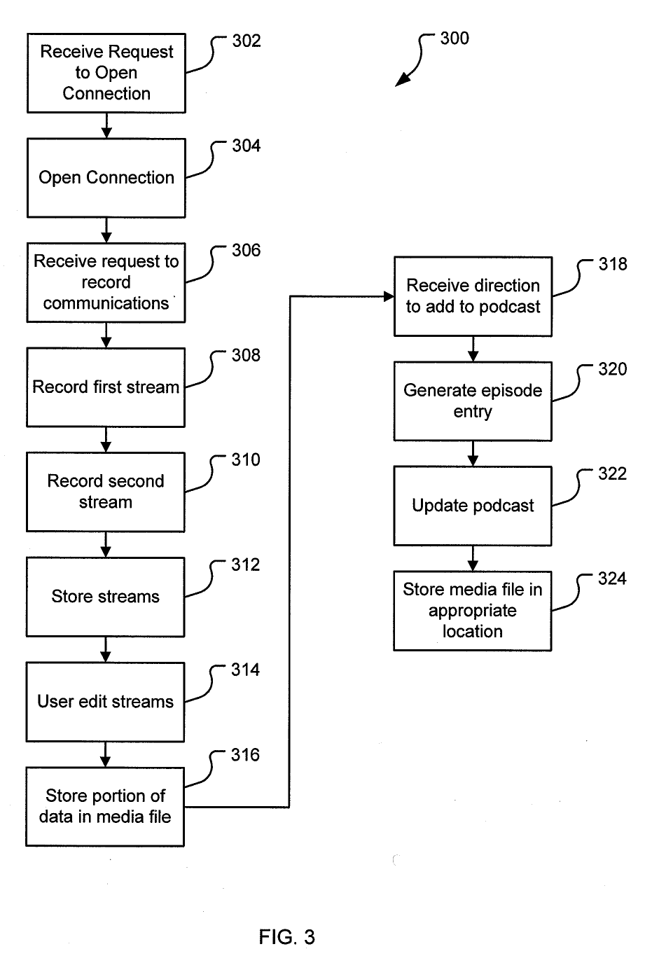

FIG. 3 illustrates a flowchart of an embodiment of a method 300 for creating and publishing an episode of a podcast. The method 300 starts with a caller initiating a call using a messenger service. As described above, in one embodiment the caller uses a computing device such as a personal computer or smart phone to interact via a communication network with a messenger server. All communications between devices then goes through the messenger server. In an alternative embodiment, some or all of the software for the messenger service resides on the caller's computing device and the caller's computing device can directly communicate with the called device without an intermediary server.

In the embodiment of the method 300 shown, the caller initiates the call by generating a request that transferred to the messenger service, which as described above could be located at a remote messenger server or on the caller's device. The request is received by the messenger service in a receive request operation 302.

The messenger service then proceeds to open a connection or otherwise initiate the communications between the caller's device and the device being called (the called device) in a connection operation 304. This may involve many different communication technologies and networks. As described above in many cases a connection may be opened between devices that utilizes many different networks and communication methods. For example, it is now possible to use a laptop computer on a wireless network to access a messenger service on a remote messenger server and use that messenger service to call (open a connection, open communications with) a traditional wired telephone. In this example, data is transferred between the devices over a wireless network with its own packet switching protocol, such as Voice Over IP (VOIP), to an wireless network antenna; over a fiber-optic network between the antenna and the messenger server; over another network between the messenger server and the telephone network access point; over the telephone network to the local hub serving the telephone being called; and, finally, over the “last mile” of traditional telephone wire to the telephone.

As the actual underlying technologies, such as VOIP, that ultimately are used to allow the two devices to communicate with each other using the messenger service are outside of the scope of this disclosure, the reader will understand that such terms as “open a connection”, “open a communication”, “connect”, “call”, “communication”, and similar terms are used herein in their broadest sense of creating the necessary conditions and providing the necessary information to the various components involved in the communication for the two devices to transfer data to and to receive data from the other device so that two-way communications occur between the devices. One skilled in the art will realize that most modern communication relies, at least at some point, on packet switched networks and protocols, in addition to or instead of the old physical electronic connection techniques used in the original telephone system. In the context of packet switched networking, such terms as “connection” often are still used because of the public's continued use of the terms to describe two or more devices that are in the state of communicating with each other.

In the method 300, one or both of the parties requests that the communication be recorded by the messenger service. In the embodiment shown, this record request is received after the communication connection has been opened. In an alternative embodiment, the record request may be made prior to the opening of the connection, such as with the request to open the connection. For example, when opening a connection the messenger service may prompt the caller, “do you wish to record this communication?”

In any case, the record request is received by the messenger service in a receive record request operation 306. In response, the messenger service begins recording the data transferred between the devices. In the embodiment shown, two distinct streams of data are recorded during the communication in operations 308 and 310. A first stream of data is recorded in a record operation 308 that contains the data transferred between the caller's device and the called device. A second stream of data is recorded in a record operation 310 that contains the data transferred between the called device and the caller's device. In an embodiment, the two streams of data may be stored independently and separately, such as in separate data files. In an alternate embodiment, some or all of the two streams may be stored in a combined data file or a combined form of some kind.

For example, audio data is relatively easy to combine into a single combined data stream as typically the parties to an audio call are not speaking at the same time, and even if that is the case, it is an accurate and interpretable recording of the communication. Therefore, in an embodiment, data that represents the spoken or audible sounds ultimately delivered to the caller and called people (the “audio data”) is stored in combined data file. Visual data, i.e., data that represents visual images and/or how images change over time, may also be transmitted between the devices. Such visual data is not relatively easy to combine into a combined data stream. Therefore, in an embodiment, visual data streams from each device may be stored separately as separately viewable streams of data.

The recording operation 308, 310 also include recording synchronization information that allows the various separately recorded streams of data to be rendered with the proper timing in order to reproduce the communications between the parties of the call. In an embodiment, synchronization information may be as simple as requiring that all recordings start at substantially the same point in time and that they should be synchronized in playback to that point. Alternatively, other synchronization information may be created that periodically confirms the proper temporal location in each data stream for correlation with the other data streams of the communication. Synchronization information may include start time information, time stamps at various locations within the data stream, and information identifying the other data streams to which a stream is associated. Synchronizing different streams of media data is known in the art and any suitable method and synchronizing information now known or later developed may be used.

The recorded streams are ultimately stored in a store recorded streams operation 312. Storage may begin prior to the completion of the call and “termination” of the connection, or the storage may be delayed until the entire contents of each data stream has been collected. In an embodiment, the data is stored in the storage operation 312 on the messenger server under the control of the messenger service. In an alternative embodiment, the data may be stored on the caller's device, the called device, or a remote data storage location. In an embodiment, the storage location may be selected by the party that transmitted the record request that initiated the recording operations 308, 310.

After the streams are stored, the streams may be edited in an edit streams operation 314. In the edit streams operation 314, the editor may select all or some of the communications for storage in a media file to be published. For example, a user may select different portions of different the streams to be combined to create a renderable media stream containing excerpts from the recorded communication.

For example, if a communication was an interview in which an interviewer called an interviewee and recorded the communications, the editor could edit out uninteresting portions of the recordings to create an edited version of the interview. Uninteresting questions and responses could be removed and the order of the questions could be changed. If the interview included audio and visual data from each of the parties, a combined stream could be created that showed the interviewer's visual stream when the interviewer was asking a question or talking and the interviewee's visual stream when the interviewee was responding to questions.

During the editing operation 314, additional material not in the communication may also be selected and provided by the editor for including the ultimately created media stream. For example, still images or video of the subject being discussed may be provided to be interleaved within the visual of the recording communication in the ultimately created media stream. In addition, alternative visual and audio streams could be provided to replace the audio and visual generated by the actual interviewer, thus giving the impression that a different interviewer performed the interview.

Various methods and systems for editing media data to create a combined media data file are known in the art and any suitable system may be used to create a renderable media file or stream of data from the recorded data of the communication. In an embodiment, the editing module may be located on the messenger server and accessed as part of the messenger service. Alternatively, the editing module may be considered and provided as a separate and independent system, however a system still capable of interacting with the recorded communications as generated by the messenger service. Alternatively, the editing module may be located at the caller's device or some other computing device that can access the recorded communications.

After editing the recorded communications, the resulting combined and edited media stream of audio, visual or audio-visual data is stored in a store media file operation 316. The media file may include data derived from many different streams that were recorded by the messenger service in the recording operations 308, 310. The media file is a renderable file of media data (audio, visual or audio-visual) that is suitable for publishing as an episode of a podcast. The data in the media file may be of the same format as that originally recorded by the messenger service or may be a different format to meet the requirements of the media file's format. Thus, even if the communication is recorded in a proprietary format known only to the messenger service, the editor module is adapted to convert data from the proprietary format into the media format of the media file type selected by the editor.

The store media file operation 316 may include storing the media file at a location on a network publicly accessible to other computers, such as the Internet. Alternatively, the media file may be stored in a private location on a network accessible only to the editor. In addition, storing the media file may include storing information associated with the media file such as the date and time the communication occurred, the parties involved, etc. Such additional information may be included as metadata in the media file. Some of the additional information may be automatically generated by the messenger service as part of the recording operation and some of the information may be automatically requested from the caller in anticipation of publication of the media file as an episode of a podcast.

After the media file is created, the method 300 allows the media file to be easily published as an episode of podcast with a minimum of interaction from the publisher. In the embodiment shown, a publisher transmits a request to the messenger service to publish the media file as an episode of a podcast, the request being received by the messenger service in a receive publication request operation 318. The request may be generated through interaction with a GUI provided by the messenger service or the editor module, if separate. For example, in an embodiment a messenger service may allow a user to initiate and record a call, edit the recorded call and store into a media file and publish the media file from a single GUI or a combined set of related GUIs.

The request received may include an identification of the podcast to be updated or the requestor may be prompted after receipt to provide this information. In addition, most podcasts have controlled access so that only the publisher or authorized individuals can modify the podcast. Such controlled access information may be provided to the publishing module or, alternatively, if the controlled access information was previously provided the publishing module may simply need to verify the identity of the requester.

After receiving the request to publish, the publication module, whether it is a part of the messenger service or an independent element, may generate data to be used in an episode entry of a podcast. As discussed above, podcast typically include an entry for each episode that includes such information as the date of publication, the title of the episode, author, category, duration, keywords, the location of the media file that is the episode sometimes referred to as a link to the media file or episode, a description of the media file, and an image to be associated with the episode if the podcast is rendered.

The publishing module may collect the information to be used in an episode entry from different sources and generate the episode entry in an episode entry generation operation 320. As discussed above, some information may be obtained from metadata in the media file, such as duration and author. Other information may have been generated by the messenger system and stored in the media file or provided directly to the publishing module by the messenger system, such as copyright date, date of the communication, description of the communication, device identifiers such as telephone numbers or URLs. And other information may be requested from and provided the publishing party as part of the episode entry generation operation 320.

The podcast is then updated in an update podcast operation 322 to include the newly generated episode entry. This may include retrieving a copy of the podcast, adding the episode entry to the text of the podcast's feed file, and overwriting the podcast with the new version. In an alternative embodiment, this may include receiving a copy of the podcast feed file from the publisher and storing a revised copy with the new episode entry at a new location on the messenger server. In yet another embodiment, a copy of the podcast may be retrieved from a podcast archive, the new entry added, and the new version of the podcast stored in the appropriate location on the network. Many different techniques are known in the art for revising a podcast to include a new episode entry and any suitable technique may be used in this operation 322.

After the podcast is updated, if the media file is already accessible via the link in the new version of the podcast, media file is considered published because it is now accessible through the podcast. Anyone subscribing to the podcast will be alerted to the existence of the new episode and will be able to access the media file through the link. In addition, anyone accessing the podcast for the first will also be able to access the media file and search engines that search the podcast will add the textual information in the podcast to their search index. Thus, updating the podcast is de facto publication of the media file may making its location and description information known to the network's users at large.

However, in the embodiment shown, the media file may not be at a publicly accessible location in the network. If that is the case, the publishing module may create a copy of the media file from its private or controlled access location and store the copy in the network location identified in the episode entry in a store media file in public location operation 324. In this embodiment, publication may be considered to be the later of the two actions, updating the podcast or storing a copy of the media file in the location identified in the episode entry.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present disclosure. For example, the methods and systems described could be adapted to conference calls between many different parties, allowing a media file to be published as an episode of a podcast that included audio and visual from many different parties to the same call. Numerous other changes may be made which will readily suggest themselves to those skilled in the art and which are encompassed in the spirit of the systems and methods disclosed and as defined in the appended claims.

What is claimed is:

1. A method comprising:
receiving, from a first device, a request to open a communication connection with a second device;
opening the communication connection;
receiving a request to record communications between the first device and the second device;
recording a first stream of data generated by the first device for transmission to the second device;
recording a second stream of data generated by the second device for transmission to the first device;
storing the first stream of data and the second stream of data;
in response to one or more first user inputs, storing a user-selected portion of the first stream of data or the second stream of data in a media file, the media file accessible at a location on a network; and
in response to one or more second user inputs, identifying the location of the media file in a podcast accessible on the network, thereby publishing the media file on the network as an episode of the podcast.

2. The method of claim 1 wherein the second device is a telephone and opening a connection further comprises:
initiating a telephone call to a telephone number via a messenger server and a telephone network, the telephone number contained in the request to open a communication connection.

3. The method of claim 1 wherein opening a connection further comprises:
receiving the first stream of data and transmitting the first stream of data to the second device; and
recording the second stream of data and transmitting the second stream of data to the first device.

4. The method of claim 1 wherein storing a user-selected portion further comprises:
receiving, via the one or more first user inputs, a selection identifying the user-selected portion as at least some of the first stream of data and at least some of the second stream of data;
synchronizing the first stream of data with the second stream of data; and
generating a user-selected portion based on a synchronized portion of the first stream of data and the second stream of data.

5. The method of claim 1 wherein the first stream of data and the second stream of data are audio data and recording further comprises:
combining the first stream of data and second stream of data into a combined audio data stream; and
storing the combined audio data stream in a communication record file.

6. The method of claim 5 wherein storing a user-selected portion further comprises:
storing a user-selected portion of the combined audio data stream from the communication record file into the media file.

7. The method of claim 1 further comprising:
generating synchronization information associated with the first stream of data and the second stream of data, the synchronization information useable to synchronize simultaneous rendering of the first stream and second stream to reproduce the communications between the first device and the second device.

8. The method of claim 1 wherein the first and second streams include audio data.

9. The method of claim 8 wherein at least one of the first and second-streams include visual data.

10. The method of claim 1 wherein identifying further comprises:
generating an episode entry, the episode entry identifying the location of the media file; and
adding the episode entry to the podcast.

11. The method of claim 10 further comprising:
recording, by the messenger server, communication information associated with the communications between the first device and the second device; and
generating at least a portion of the episode entry from the communication information.

12. The method of claim 11 further comprising:
receiving, via the first or second user-inputs, the communication information.

13. The method of claim 11 further comprising:
generating at least a portion of the communication information based on the request to open the communication connection with the second device.

14. A system for publishing an episode of a podcast comprising:
a messenger module adapted to communicatively connect a client computing device with a second device and further adapted to record a first communication data stream from the client computing device and a second communication data stream from the second device;
an editing module adapted to create a media file containing data selected from the first communication data stream and the second communication data stream; and
a podcast publishing module adapted to generate an episode entry corresponding to the media file in the podcast, the episode entry identifying the media file as the episode.

15. The system of claim 14 wherein the messenger module, the editing module and the podcast publishing module are located on a server computer remote from the client computing device and the second device.

16. The system of claim 15 wherein the client computing device controls the operation of the messenger module, the editing module and the podcast publishing module.

17. The system of claim 14 wherein the client computing device communicates with the messenger module, the editing module and the podcast publishing module via a browser application on the client computing device.

18. The system of claim 14 wherein the editing module

19. The system of claim 14 wherein the second device is a telephone.

20. The system of claim 14 wherein the second device is a cellular telephone.

21. The system of claim 14 wherein the second device is a second computing device.

22. The system of claim 14 wherein the episode entry generated by the podcast publishing module includes description information automatically generated by the messenger module, the description information different than the first communication data stream and the second communication data stream.

23. The system of claim 14 wherein the episode entry generated by the podcast publishing module includes description information provided by the client computing device describing the episode.

24. The system of claim 14 wherein the episode entry generated by the podcast publishing module includes description information automatically generated by the editing module describing characteristics of the media file.

25. A method comprising:
initiating a communication between at least two communication devices, including a first communication device and a second communication device, using a messenger server;
recording, by the messenger server in response to a first selection made by at least one of the two communication devices, media data passed between the two communication devices during the communication; and
generating a media file derived from at least some of the media data passed between the two communication devices during the communication, the media file when rendered reproducing at least a portion of the communication between the two communication devices.

26. The method of claim 25 further comprising:
publishing, by the messenger server in response to a second selection made by at least one of the two communication devices, the media file as an episode of a podcast.

27. The method of claim 26 wherein the media file contains audio and visual information passed between the two communication devices through the messenger server.

28. The method of claim 26 wherein recording further comprises:
recording first data generated by the first communication device and transmitted through the messenger server to the second communication device during the communication;
separately recording second data generated by the second communication device and transmitted through the messenger server to the first communication device during the communication; and
recording synchronization information that associates the first data with the second data.

29. The method of claim 28 wherein generating the media file comprises:
receiving a user selection of first data and second data to be combined into the media file;
generating a combined data stream that when rendered reproduces at least a portion of the communication between the two communication devices; and
storing the combined data stream in the media file at a location on a network.

30. The method of claim 29 wherein publishing by the messenger server further comprises:
receiving a selection of the podcast;
generating an episode entry that identifies the location of the media file on the network; and
revising the podcast to include the episode entry.

31. The method of claim 25 wherein at least one of the communication devices is a computing device using a browser to interact with the messenger server.

32. The method of claim 25 wherein at least one of the communication devices is a telephone interacting with the messenger server via a telephone network.

33. A method of creating and publishing an episode using a messenger service comprising:
initiating, from a first computing device, a communication through a messenger service with a second device;
directing the messenger service to record the communication;
after the communication, directing the messenger service to create a media file renderable to reproduce at least a portion of the communication; and
directing the messenger service to publish the media file as an episode of a podcast.

34. The method of claim 33 wherein the second device is a telephone and initiating further comprises:
providing a telephone number for the second device.

35. The method of claim 33 wherein the second device is a computing device and initiating further comprises:
providing a messenger identifier associated with the second device from which the messenger determines an IP address for the second device.

36. The method of claim 33 wherein directing the messenger service to publish the media file further comprises:
identifying the podcast; and
providing information necessary for accessing the podcast.
